(19) United States
(12) Patent Application Publication
(10) Pub. No.: US 2017/0372203 A1
(43) Pub. Date: Dec. 28, 2017

(54) AUTOMATED FILTERING OF STORY CONTENT BASED ON EMOTIONS

(71) Applicant: International Business Machines Corporation, Armonk, NY (US)

(72) Inventors: Harish Bharti, Pune (IN); Sanjib Choudhury, Pune (IN); Kshitij K. Raval, Pune (IN); Rajesh K. Saxena, Pune (IN)

(21) Appl. No.: 15/194,707

(22) Filed: Jun. 28, 2016

(51) Int. Cl. G06N 5/02; G06Q 10/10

(52) U.S. Cl. CPC G06N 5/02; G06Q 10/10

(57) ABSTRACT

Machine logic based automated story writing technology that: respectively represents content data sources for potential use in an automated story as nodes in a graph; includes emotion metadata in each given node of the graph, with the emotion metadata relating to “emotions” (“sentiments”) that are likely to be caused in story consumers and/or story characters if the content corresponding to the given node is used in an automated story; use the emotion metadata to help select a sub-set of nodes whose respectively associated content is to be used in an automated story; and use the emotion metadata to help select the order of the use of the content nodes in an automated story. The selection of the nodes based on emotion metadata and/or the ordering of the nodes based on emotion metadata may be further based on seed information (for example, story seed information supplied by a human co-author).

### BACKGROUND

The present invention relates generally to the field of automated story writing (that is machine logic for writing narrative stories (fiction or non-fiction) based upon “story seed data” and data source content), and more particularly to selecting and/or ordering data content sources for use in the automated story.

Emotion (sometimes also referred to herein as “sentiments”) is herein used to mean any mental feeling, mood, temperament, frame of mind and/or mental bias or tendency toward a given motivation. Emotions can be broken down into types, at varying degrees of granularity. For example, a relatively course breakdown of emotion types is as follows: (i) happy, (ii) sad, (iii) angry, (iv) thoughtful and (v) bored. Other possible emotion types include, but are not limited to the following: calm, mentally fatigued, livid, sympathetic, empathetic, generous, spaced out, weepy, sybaritic, nervous, frantic, contemplative, focused, naughty, morose, lachrymose, confused, quizzical, wonderment, scattered, lonesome, amused, disappointed, cheery, annoyed, displeased, confident and/or existential. Real people and some animals feel emotions, and emotions are also sometimes ascribed to fictional characters. Stories (whether fictional or non-fictional) may: (i) give rise to emotions (predictable or unpredictable) in the hearer or reader of the story; and (ii) have participants or actors who have, or have ascribed to them, emotions.

### SUMMARY

According to an aspect of the present invention, there is a method for writing an automated story that performs the following operations (not necessarily in the following order): (i) receiving, by an automated story writing engine, a story data graph data set including data structured as a graph that includes a plurality of nodes and a plurality of connections among and between the nodes, with each given node including content data corresponding to content that can potentially be used as subject matter for the automated story and emotion value data relating to emotions related to the content of the given node; (ii) receiving, by the automated story writing engine, a selected emotions data set corresponding to emotions that are desired to be used in the automated story; (iii) selecting, by the automated story writing engine, a subset of recommended candidate nodes from the plurality of nodes, based, at least in part, upon the selected emotions data set and the emotion value data of the nodes of the story data graph; and (iv) outputting data corresponding to an identity of the recommended candidate nodes.

According to a further aspect of the present invention, there is a computer program product for writing an automated story that performs the following operations (not necessarily in the following order): (i) receiving, by an automated story writing engine, a story data graph data set including data structured as a graph that includes a plurality of nodes and a plurality of connections among and between the nodes, with each given node including content data corresponding to content that can potentially be used as subject matter for the automated story and emotion value data relating to emotions related to the content of the given node; (ii) receiving, by the automated story writing engine, a selected emotions data set corresponding to emotions that are desired to be used in the automated story; (iii) selecting, by the automated story writing engine, a subset of recommended candidate nodes from the plurality of nodes, based, at least in part, upon the selected emotions data set and the emotion value data of the nodes of the story data graph; and (iv) outputting data corresponding to an identity of the recommended candidate nodes.

According to a further aspect of the present invention, there is a system for writing an automated story that performs the following operations (not necessarily in the following order): (i) receiving, by an automated story writing engine, a story data graph data set including data structured as a graph that includes a plurality of nodes and a plurality of connections among and between the nodes, with each given node including content data corresponding to content that can potentially be used as subject matter for the automated story and emotion value data relating to emotions related to the content of the given node; (ii) receiving, by the automated story writing engine, a selected emotions data set corresponding to emotions that are desired to be used in the automated story; (iii) selecting, by the automated story writing engine, a subset of recommended candidate nodes from the plurality of nodes, based, at least in part, upon the selected emotions data set and the emotion value data of the nodes of the story data graph; and (iv) outputting data corresponding to an identity of the recommended candidate nodes.

According to a further aspect of the present invention, there is a computer-implemented method for writing an automated story that performs the following operations (not necessarily in the following order): (i) receiving, by an automated story writing engine, a story data graph data set including data structured as a graph that includes a plurality of nodes and a plurality of connections among and between the nodes, with each given node including content data corresponding to content that can potentially be used as subject matter for the automated story and emotion value data relating to emotions related to the content of the given node; (ii) receiving, by the automated story writing engine, an emotion ordering data set corresponding to an order of emotions that is desired to be used in the automated story; (iii) determining, by the automated story writing engine, an ordering for a subset of nodes, with the subset of nodes including at least some nodes of the plurality of nodes, based, at least in part, upon the emotion ordering data set and the emotion value data of the nodes of the story data graph; and (iv) outputting data corresponding to the ordering of the subset of nodes.

According to a further aspect of the present invention, there is a computer program product for writing an automated story that performs the following operations (not necessarily in the following order): (i) receiving, by an automated story writing engine, a story data graph data set including data structured as a graph that includes a plurality of nodes and a plurality of connections among and between the nodes, with each given node including content data corresponding to content that can potentially be used as subject matter for the automated story and emotion value data relating to emotions related to the content of the given node; (ii) receiving, by the automated story writing engine, an emotion ordering data set corresponding to an order of emotions that is desired to be used in the automated story; (iii) determining, by the automated story writing engine, an ordering for a subset of nodes, with the subset of nodes including at least some nodes of the plurality of nodes, based, at least in part, upon the emotion ordering data set and the emotion value data of the nodes of the story data graph; and (iv) outputting data corresponding to the ordering of the subset of nodes.

According to a further aspect of the present invention, there is a system for writing an automated story that performs the following operations (not necessarily in the following order): (i) receiving, by an automated story writing engine, a story data graph data set including data structured as a graph that includes a plurality of nodes and a plurality of connections among and between the nodes, with each given node including content data corresponding to content that can potentially be used as subject matter for the automated story and emotion value data relating to emotions related to the content of the given node; (ii) receiving, by the automated story writing engine, an emotion ordering data set corresponding to an order of emotions that is desired to be used in the automated story; (iii) determining, by the automated story writing engine, an ordering for a subset of nodes, with the subset of nodes including at least some nodes of the plurality of nodes, based, at least in part, upon the emotion ordering data set and the emotion value data of the nodes of the story data graph; and (iv) outputting data corresponding to the ordering of the subset of nodes.

According to a further aspect of the present invention, there is a computer-implemented method for writing an automated story that performs the following operations (not necessarily in the following order): (i) receiving, by an automated story writing engine, a story data graph data set including data structured as a graph that includes a plurality of nodes and a plurality of connections among and between the nodes, with each given node including content data corresponding to: (a) content that can potentially be used as subject matter for the automated story, and (b) emotion value data relating to emotions related to the content of the given node; (ii) receiving, by the automated story writing engine and from a seeder entity, emotion seed data relating emotions and/or emotional flow that the automated story is desired to exhibit; (iii) for each given node of the story data graph, translating the emotion value data in the form of a color value for the given node; (iv) identifying a maximum chromatic polynomial required to adequately cover emotion seed data based, at least in part, upon the color values of the nodes of the story data graph; (v) identifying a minimum chromatic polynomial required to adequately cover emotion seed data based, at least in part, upon the color values of the nodes of the story data graph; and (vi) identifying relationships of the maximum chromatic polynomial and the minimum chromatic polynomial by mapping emotions identified by the minimum and maximum chromatic polynomials.

According to a further aspect of the present invention, there is a computer program product for writing an automated story that performs the following operations (not necessarily in the following order): (i) receiving, by an automated story writing engine, a story data graph data set including data structured as a graph that includes a plurality of nodes and a plurality of connections among and between the nodes, with each given node including content data corresponding to: (a) content that can potentially be used as subject matter for the automated story, and (b) emotion value data relating to emotions related to the content of the given node; (ii) receiving, by the automated story writing engine and from a seeder entity, emotion seed data relating emotions and/or emotional flow that the automated story is desired to exhibit; (iii) for each given node of the story data graph, translating the emotion value data in the form of a color value for the given node; (iv) identifying a maximum chromatic polynomial required to adequately cover emotion seed data based, at least in part, upon the color values of the nodes of the story data graph; (v) identifying a minimum chromatic polynomial required to adequately cover emotion seed data based, at least in part, upon the color values of the nodes of the story data graph; and (vi) identifying relationships of the maximum chromatic polynomial and the minimum chromatic polynomial by mapping emotions identified by the minimum and maximum chromatic polynomials.

According to a further aspect of the present invention, there is a system for writing an automated story that performs the following operations (not necessarily in the following order): (i) receiving, by an automated story writing engine, a story data graph data set including data structured as a graph that includes a plurality of nodes and a plurality of connections among and between the nodes, with each given node including content data corresponding to: (a) content that can potentially be used as subject matter for the automated story, and (b) emotion value data relating to emotions related to the content of the given node; (ii) receiving, by the automated story writing engine and from a seeder entity, emotion seed data relating emotions and/or emotional flow that the automated story is desired to exhibit; (iii) for each given node of the story data graph, translating the emotion value data in the form of a color value for the given node; (iv) identifying a maximum chromatic polynomial required to adequately cover emotion seed data based, at least in part, upon the color values of the nodes of the story data graph; (v) identifying a minimum chromatic polynomial required to adequately cover emotion seed data based, at least in part, upon the color values of the nodes of the story data graph; and (vi) identifying relationships of the maximum chromatic polynomial and the minimum chromatic polynomial by mapping emotions identified by the minimum and maximum chromatic polynomials.

### BRIEF DESCRIPTION OF THE DRAWINGS

FIG. 1A is a block diagram of a first embodiment of a system according to the present invention;

FIG. 1B is a block diagram of a portion of the first embodiment system;

FIG. 2 is a flowchart showing a first embodiment of a method performed, at least in part, by the first embodiment system;

FIG. 3 is a block diagram showing a machine logic (for example, software) portion of the first embodiment system;

FIG. 4 is a portion of a story data graph used by the first embodiment system in performing the first embodiment method;

FIG. 5A is a block diagram showing information that is helpful in understanding embodiments of the present invention;

FIG. 5B is a table summarizing operations performed by embodiments of the present invention;

FIG. 6 is a graph of a second embodiment of a method according to the present invention; and

FIG. 7 is a graph of a second embodiment of a method according to the present invention.

### DETAILED DESCRIPTION

Some embodiments of the present invention: (i) respectively represent content data sources for potential use in an automated story as nodes in a graph; (ii) include emotion metadata in each given node of the graph, with the emotion metadata relating to “emotions” (see definition, above) that are likely to be caused in story consumers (for example, human readers, human listeners) and/or story characters if the content corresponding to the given node is used in an automated story; (iii) use the emotion metadata to help select a sub-set of nodes whose respectively associated content is to be used in an automated story; and/or (iv) use the emotion metadata to help select the order of the use of the content nodes in an automated story. This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

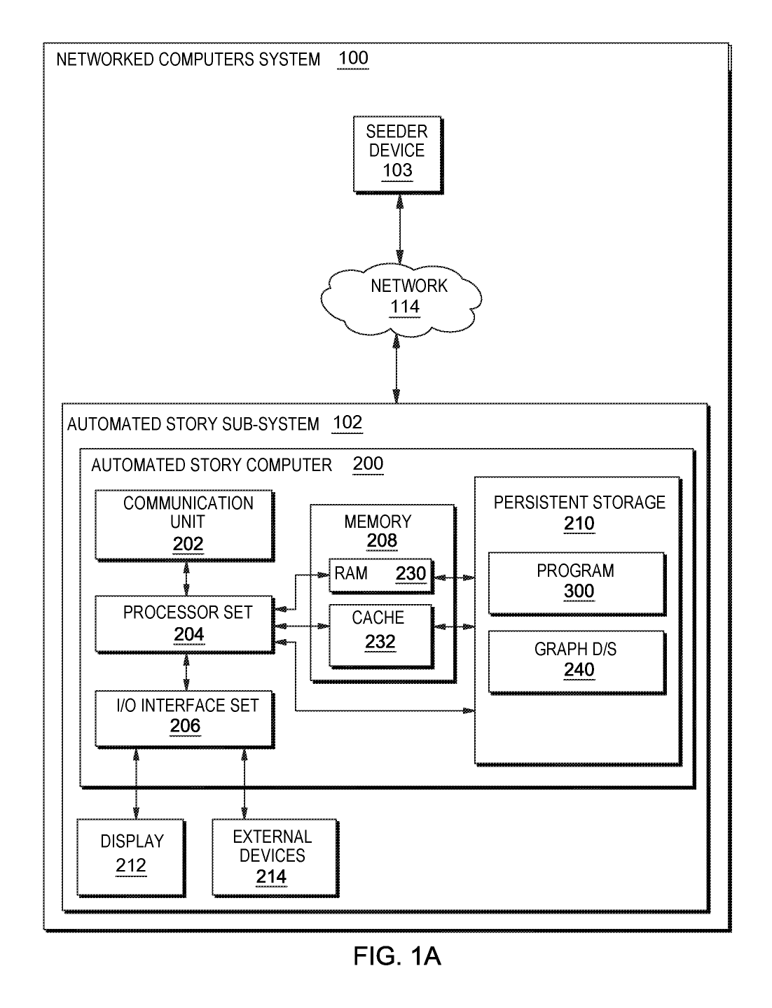

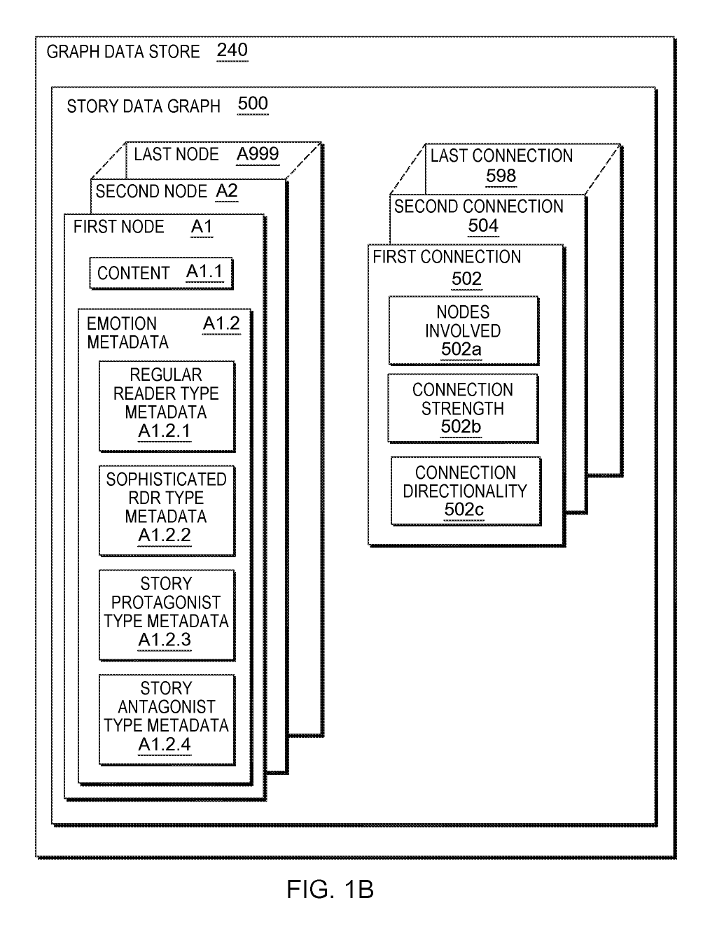

An embodiment of a possible hardware and software environment for software and/or methods according to the present invention will now be described in detail with reference to the Figures. FIGS. 1A and 1B are, collectively, a functional block diagram illustrating various portions of networked computers system 100, including: automated story sub-system 102; seeder device 103; automated story computer 200; communication unit 202; processor set 204; input/output (I/O) interface set 206; volatile memory 208; persistent storage 210; display device 212; external device set 214; random access memory (RAM) 230; cache 232; graph data store 240; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

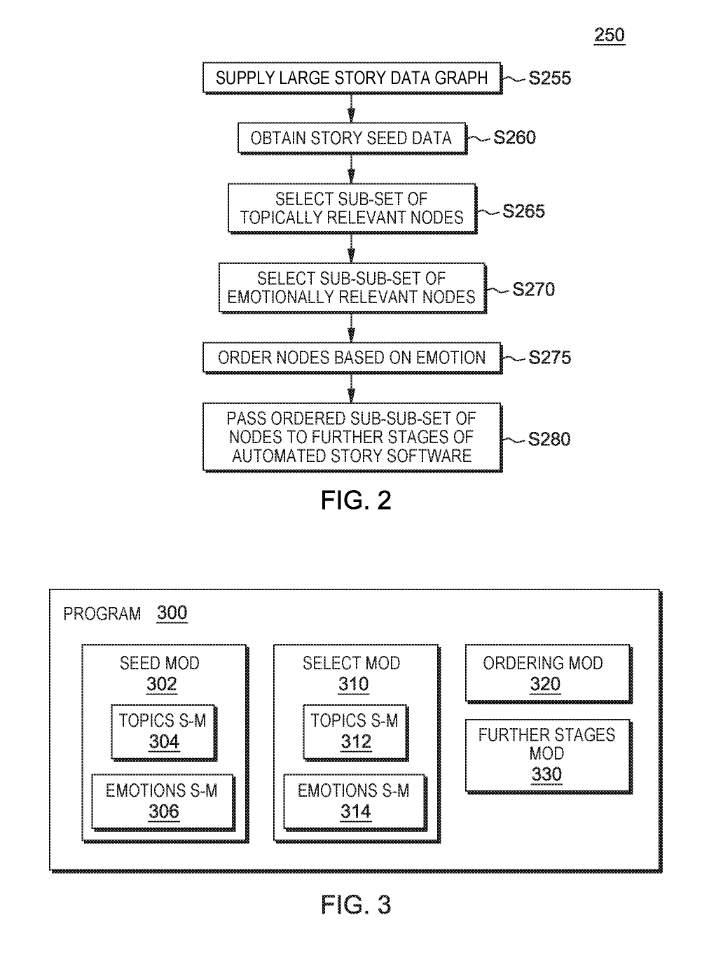

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

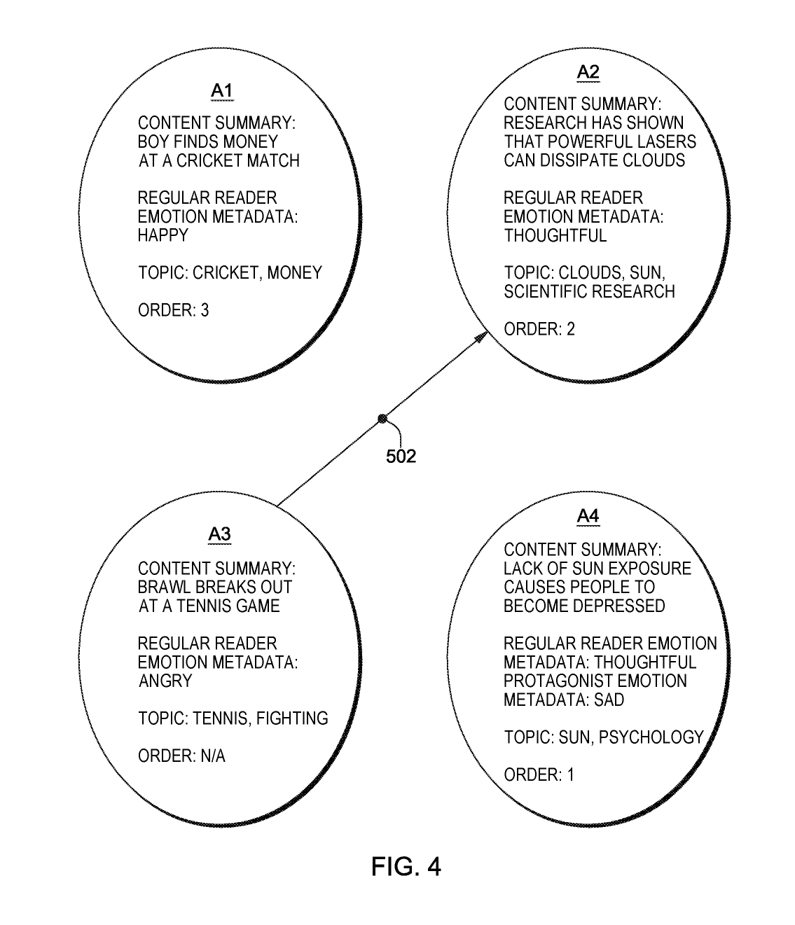

Processing begins at operation S255, where graph data store 240 (see FIGS. 1A and 1B) receives story data graph 500. As shown in FIG. 1B, story data graph includes nine hundred ninety-nine (999) nodes A1 to A999 and about 48 connections (also sometimes herein referred to as edges) 502 to 598. FIG. 4 shows a portion of story data graph 500 that includes four (4) nodes A1, A2, A3 and A4 and one (1) connection 502. As shown at first node block A1 in FIG. 1B, in this embodiment, each node received at operation S255 includes: (i) content A1.1 (for example, data corresponding to natural language text, data corresponding to audio video data, etc.); and (ii) emotion metadata A1.2, including the following types of emotion metadata: (a) regular reader type emotion metadata A1.2.1 (that is, emotions likely to be induced in a reader of an average sophistication level), (b) sophisticated reader type emotion metadata A1.2.2 (that is, emotions likely to be induced in a reader of a relatively high sophistication level), (c) protagonist type emotion metadata A1.2.3 (that is, emotions likely to be felt by characters (fictional or non-fictional) of the story who are considered as protagonists), and (d) antagonist type emotion metadata A1.2.4 (that is, emotions likely to be felt by characters (fictional or non-fictional) of the story who are considered as antagonists). Alternatively, other embodiments may include more or fewer types of emotion metadata (for example, embodiments with a single type of emotion metadata).

In this simple embodiment, only four emotions are used: HAPPY, SAD, ANGRY and THOUGHTFUL. Other embodiments may include many more possible emotion metadata values to allow more granularity with respect to emotion. As may be discussed, below, some embodiments may use color spaces to host emotion values which are represented as colors.

FIG. 4 shows nodes A1, A2, A3 and A4, including for each node: (i) a summary of their respective content (with this “content” including topic keywords as shown in FIG. 4); and (ii) some of the emotional metadata respectively associated with each of these nodes. In this embodiment, the emotion metadata is determined by humans, before story data graph is received at operation S255. Alternatively, the emotion metadata may be determined by machine logic. This emotion metadata of nodes A1, A2, A3 and A4 will be used in later operations of method 250, as will be further discussed, below.

Moving back to FIG. 1B, story data graph 500, as received at operation S255, also includes connections 502 to 598, with each connection including: (i) nodes involved in the connection (see FIG. 1B at nodes involved block 502a); (ii) connection strength (see FIG. 1B at connection strength block 502b); and (iii) directionality of the connection (see FIG. 1B at connection directionality block 502c). FIG. 4 shows connection 502, which is characterized by the following values: (i) nodes involved=A2, A3; (ii) connection strength=3.14; and (iii) connection directionality from A3 to A2. These pairwise connections of story data graph 500 are determined based on content and/or context of the content data sources respectively corresponding to the nodes. In this embodiment, this data is not really used in method 250, but it should be noted that these connections can be used to help select nodes and/or ordering for the story. In other words, the emotion metadata, which is considered in some detail in method 250, is not typically the only factor used to select content and/or ordering on node content for purposes of writing an automated story. Although it is beyond the scope of this document to explain how the connections of story data graph help shape the automated story, one of skill in the art will appreciate that, at least in some embodiments, the connections do help shape the automated story end product of method 250.

Processing proceeds to operation S260, where seed module (“mod”) 302 receives story seed input data from seeder device 103 (for example, a word processing program running on a laptop computer) through communication network 114 (see FIG. 1A). In this embodiment, a human user supplies the story seed input data. Alternatively, the story seed input data could be supplied by machine logic. Generally speaking, the story seed input data includes information indicative, or descriptive, of how the automated story should turn out, but, of course, the story seed input data will be less elaborate and detailed than the finished story to be composed, in an automated fashion with substantially no human intervention (see definition, below, of “without substantial human intervention”) by program 300. More specifically, story seed input data may include one or more of the following types of seed information: topics, emotions, order of emotions, genre, context, key words or phrases, theme, mood, setting, time, place, emotional content, general outline.

In this example of method 250, the story seed input data is as follows: “The story should include the following topic(s): (i) the sport of cricket; and (ii) psychology. The emotional flow should be as follows: (i) SAD; then (ii) THOUGHTFUL; and then (iii) HAPPY. The story should avoid any hint of the emotion of ANGER.” In this example: (i) the topics for the story are detected by machine logic of topics sub-mod 304 of seed mod 302; and (ii) the emotions and order of emotions is determined by machine logic of emotions sub-mod 306 of seed mod 302.

In this example, the story seed input data is in the form of a short narrative passage written in natural language (specifically, English language). Alternatively, this data could take the form of a set of records, with field values, in a structured database. As a further alternative any data set, structured or unstructured, human understandable or machine readable, could be used so long it has a sufficient quantity and quality of seed information to seed an automated story.

Processing proceeds to operation S265, where machine logic of topics sub-mod 312 of select mod 310 selects a sub-set of nodes A1 to A999 of story data graph 500 based on how closely the topics of their respective content matches the topics specified in the seed data. In this example, sub-mod 312 selects the following nodes for the following reasons: (i) node A1 (see FIG. 4) is selected because its content involves the sport of cricket as specified in the seed data received at operation S260; (ii) node A2 (see FIG. 4) is selected because its content involves scientific research, which is considered to be related to the topic of psychology as specified in the seed data received at operation S260; (iii) node A3 (see FIG. 4) is selected because its content involves the sport of tennis, which is considered to be similar to the sport of cricket as specified in the seed data received at operation S260; (iv) node A4 (see FIG. 4) is selected because its content involves psychology as specified in the seed data received at operation S260; and (v) node A56 (not separately shown in the Figures) is selected because its content involves the psychology of cricket players which relates to the topics specified in the seed data received at operation S260.

Processing proceeds to operation S270, where machine logic of emotions sub-mod 314 of select mod 310 selects a sub-set of selected (previously at operation S265) nodes A1, A2, A3, A4 and A56 of story data graph 500 (node A56 is not separately shown in the Figures) based on how closely their emotions match and/or avoid the emotions called for and/or forbidden in the seed data previously received at operation S260.

In this example, sub-mod 314 selects, and declines to select, the following nodes for the following reasons: (i) node A1 (see FIG. 4) is selected because its regular reader type emotional metadata is HAPPY as specified in the seed data received at operation S260; (ii) node A2 (see FIG. 4) is selected because its regular reader type emotional metadata is THOUGHTFUL as specified in the seed data received at operation S260; (iii) node A3 (see FIG. 4) is not selected because its regular reader type emotional metadata is ANGRY as specified in the seed data received at operation S260; (iv) node A4 (see FIG. 4) is selected because its protagonist type emotional metadata is SAD as specified in the seed data received at operation S260; and (v) node A56 (not separately shown in the Figures) is rejected for reasons similar to those discussed, above, in connection with the rejection of node A3. In this embodiment, the machine logic of 314 is such that regular reader type emotion metadata is preferably used, but protagonist type emotion metadata can be used in the absence of regular reader type emotion metadata. The way that different types of emotion metadata (in embodiments that have multiple types of emotion metadata) are handled in selecting nodes for the automated story are a matter of design choice, as will be readily understood by those of skill in the art. A broader point for the reader to understand from this review of operation S270 is that, in some embodiments of the present invention, emotion metadata is used to help select nodes for inclusion in an automated story.

Processing proceeds to operation S275, where machine logic of ordering mod 320 orders the sub-sub-set of selected (previously at operations S265 and S270) nodes A1, A2 and A4 of story data graph 500 so that the content of the nodes will be used in an order that reflects the desired order of reader emotions specified in the seed data previously received at operation S260 (in this example: SAD, then THOUGHTFUL, then HAPPY. As can be seen by reviewing the emotion metadata in FIG. 4, this leads to the following order: (i) first node A4; then (ii) node A2; and then (iii) node A1. Method 250 includes both node selection of recommended candidate nodes (operation S270) and recommended ordering of nodes (operation S275). Alternatively, other methods according to the present invention: (i) may include node selection without ordering; and/or (ii) node ordering without node selection.

Processing proceeds to operation S280, where further stages mod 330 applies machine logic corresponding to further stages of the automated story process. During these further stages, the identity of the nodes used and/or their order may be changed somewhat, but, even in embodiments where that happens the identity and/or ordering of the content in the finished automated story will still be influenced by the analysis of the emotion metadata as discussed in connection with method 250.

A full discussion of possible further stages of the automated story process is outside of the scope of this document. However, an example automated story, that shows how an automated story is influenced in its content and/or ordering based on a consideration of emotion metadata will now be set forth in the following paragraph(s).

THE PROFESSOR'S SUNSHINE MACHINE: SAD portion based on content of node A4: It had been raining in the village for many weeks without respite. The rain fell as an unending stream of tears from a troubled student who has failed his math exam. The rain fell under command of gravity's invisible hand, as if the center of the Earth held an enormous bear who had just woken up from a long winter's sleep, whose thirst could not be quenched and who, therefore, kept shoving paw-fulls of water into his dry mouth, dusty with the flavor of his hibernation cave. The people of the village sat on their porches and watched the drip, drip, drip of the rain, listlessly, with increasing sadness that was increasing at an increasing rate with the rate of increase of the rate of increase itself increasing, marginally, with each and every cloud-blocked photon shed by the Sun eight (8) minutes earlier. While the muscles of the villagers were degrading through lack of robust activity, their prefrontal cortices, especially in that gloomiest region called “the Brodmann's area,” were working overtime, as laborers do when the vegetable plants in the fields ready themselves for harvest only a mere week before first frost is expected. The people were depressed, all right.

THOUGHTFUL portion based on content of node A2: Then the Professor came wheeling into town, wet, slick and shiny, on his recumbent bicycle, his eyes glowing madly like embers sucking oxygen and turning it into pure orange glow soaking in a bath of pure orange heat. The Professor was deep in thought—he was thinking about how to stop the rain. He thought about clouds, trying to, in his mind, look at them from both sides now. Why do clouds gather themselves together? Why do they block the Sun and the Moon? Why do they rain water down on the giant bear that lives inside of the Earth? The Professor asked Srinath for a mirror. He looked into his own eyes and saw the glow and felt the heat, and the answer came to him at once: ENERGY! The clouds lacked energy, which lack made them pull together into clouds, and, then, huddle still closer to transmogrify themselves into little bundles of di-hydrogen monoxide. However, if enough energy were delivered to the clouds, hypothesized the Professor, then the clouds would break back into thin air and let the sun shine down on the Earth below. The great bear that lives in the Earth would pause in his draught, and, hopefully, avoid a belly cramp, while the crops grew and the children played—that is, if his plan worked.

HAPPY portion based on content of node A1: The Professor pulled a high energy laser from his unzipped backpack and shot it up at the dripping grey cloud ceiling. After about twenty (20) minutes of scanning over the underside of the clouds with the laser, the clouds dissipated into thin air, just as the Professor predicted they would. The village's children gathered together for a game of cricket under the cheerfully self-immolating eye of the Sun. Srinath found an abandoned ten pound note in the reedy, wet grass beyond the cricket grounds. Nobody claimed it for ten days so Srinath got to keep the money and was able to buy a new potato peeler for his father and a jade carving of a pelican for his mother, which made them both happy, and, in turn, that made Srinath happy from the warm feeling one gets from giving to loved ones. During this time everyone played in the sun and became happy again. The Professor left the village, but he gave Srinath his cell number, and told them to hit him up with a text if it ever rained again for more than two weeks in a row. THE END.

### III. Further Comments and/or Embodiments

Some embodiments of the present invention recognize the following facts, potential problems and/or potential areas for improvement with respect to the current state of the art: (i) stochastic models assume that the variables are not-interdependent; (ii) game theory models expect a set number of variables, and do not give a degree of flexibility to modify the number of variables for different iterations; (iii) probability theory (a) does not account for the inter-relationships, (b) applies distribution models to singletons (a singleton is a set with exactly one element), (c) does not account for decisions to be uncertain, and (d) does not self-learn over iterations; (iv) weighted averages (a) do not take into account the interrelationships, and (b) do not allow past evidence to be attached; (v) multivariate analysis models (a) do not allow for the variables to change the relationships over different iterations, and (b) do not allow past evidence to be attached; and/or (vi) conventional sentiment analysis tools perform sentiment analysis of a given subject but sentiment analysis, by itself, cannot be used to create a cohesive story.

Some embodiments of the present invention may include one, or more, of the following features, characteristics and/or advantages: (i) provides a structured approach for mining data that is available from social media, internet and other sources; (ii) putting the mined data together into a cohesive story with a desired set of emotions; (iii) provides a comprehensive analysis and mathematical model justification; (iv) can be applied to create a story for movie or a book including bringing out a cohesive story along with a desired set of emotions; (v) provides a method for generating a story itself; (vi) creates a complete story from huge range of sources with unrelated content; (vii) provides to an audience a rich experience which is mixed with desired set of emotions and messages; (viii) brings in different emotions and meaningful sequences; (ix) writes a cohesive story from a wide range of sources and which do not necessarily provide multi-media type of data; and/or (x) does not require a story script as input.

There are many conventional tools available to perform sentiment analysis of a given subject but sentiment analysis, by itself, cannot be used to create a cohesive story.

Summaries of two operations will be respectively presented in the following two paragraphs. FIRST OPERATION: Developing key sentiments that will be identified with various components of a story. SECOND OPERATION: Contextualizing the data with the identified sentiments.

In the first operation, developing key sentiments, sentiments that are pertinent with the genre of the story are articulated. These sentiments become pivotal elements to further classification of the content. This first operation includes the following sub-operations: (i) identifying the maximum and minimum color (chromatic) polynomials required to adequately cover a graph where the graph includes nodes, each of which represents a content data set; and/or mapping the sentiments identified with individual chromatic polynomials. Outputs of the first operation are as follows: (i) mapping sentiments as colors; (ii) chromatic numbering; and/or (iii) setting relationships of chromatic polynomials.

In the second operation, contextualizing the data, using sentiments from the first operation as a taxonomical representation of classification is finalized. The sentiments are attributed to various sub-components of the content. This second operation includes the following sub-operations: (i) coloring the graph according to the chromatic polynomial derived from the first operation (see the paragraph above); and/or (ii) identifying a minimal set that covers all vertices or edges of the graph. Outputs of the second operation are as follows: (i) coloring of the graph; (ii) chromatic partitioning of the graph; (iii) forming independent sets; (iv) matching (maximal and minimal); and/or (v) covering.

1. Pertinent Sentiments

Sentiments that are pertinent with the genre of a story are specified (or articulated) by, for example, a human author. These sentiments become the pivotal elements in further classification of the content.

a. Sentiments specified by the author represent the number of sentiments that are desired to be brought out in the graph (the author is given flexibility to choose any number of sentiments and check if these sentiments are represented in the graph of findings. (If the desired sentiments are not represented in the graph, the data-mining search can be continued to bring in more potential content.)

b. The minimum and maximum color (chromatic) polynomials that are required to adequately cover the graph (sentiments are mapped as colors) are identified.

c. Sentiments identified with individual chromatic polynomials are mapped to identify relationships of chromatic polynomials.

d. This model determines how many (maximum) sentiments can be used to create a plot based on the findings. Accordingly, the graph is made sacrosanct, and derives the maximum number of sentiments the author can use so that the plot is not diluted with high number of emotions. This number is given by a chromatic number of the graph.

2. Chromatic Polynomials.

Use of sentiments identified as a taxonomical representation of classification, is finalized as discussed in the following few paragraphs. The sentiments are attributed to various sub-components of the graph.

a. Color the Graph.

Colors are applied to the graph according to the chromatic polynomial derived as described in the paragraph above. Proper coloring of a graph provides a basis for partitioning of the vertices into different subsets. (Proper coloring of a graph means that no two vertices sharing the same edge have the same color.) No two vertices in any of these subsets are adjacent. Such a subset of vertices is called an independent set. The largest independent set represents the color intensity or the intensity of the sentiment in the current graph. The largest independent set indicates what the prevalent sentiment in the articles is, and gives the author the flexibility to build a plot around the pivotal sentiment he or she has applied.

b. Identify a Minimal Set.

Identify a minimal set that covers all vertices or edges of the graph for desired sentiments. The author has n number of articles in the library being represented by the graph G. Thus the author is provided at least minimum vertex covering instances of articles that can be used for the story line. The author also has sentiments that draw independent sets of which the largest set has maximum number of articles in the disposition. He or she can take this as the pivotal article and collect other related independent sets for the sub-componentization or further classification. The maximum reach of the research is given by the minimum edge covering computation.

Some embodiments of the present invention may include one, or more, of the following features, characteristics and/or advantages: (i) is a revolutionary concept in story writing that produces rich and appealing stories drawing on a large number of diversified sources of content (can be publicly available content and any other content to which the author has licensed access); (ii) presents a strong collaborative platform for story writing of television serials; (iii) enhances the quality and appeal of speeches given by political leaders (president, governors, other leaders) and organizational leaders who attempt to influence emotions of their listeners in a manner similar to the way human authors traditionally try to influence the emotions of their readers; and/or (iv) presents enhanced feasibility of collaborative writing without current limitations.

Before proceeding with bringing emotions into the input content, the input content is first arranged in the form of graph where input content is represented as nodes and linkages as edges.

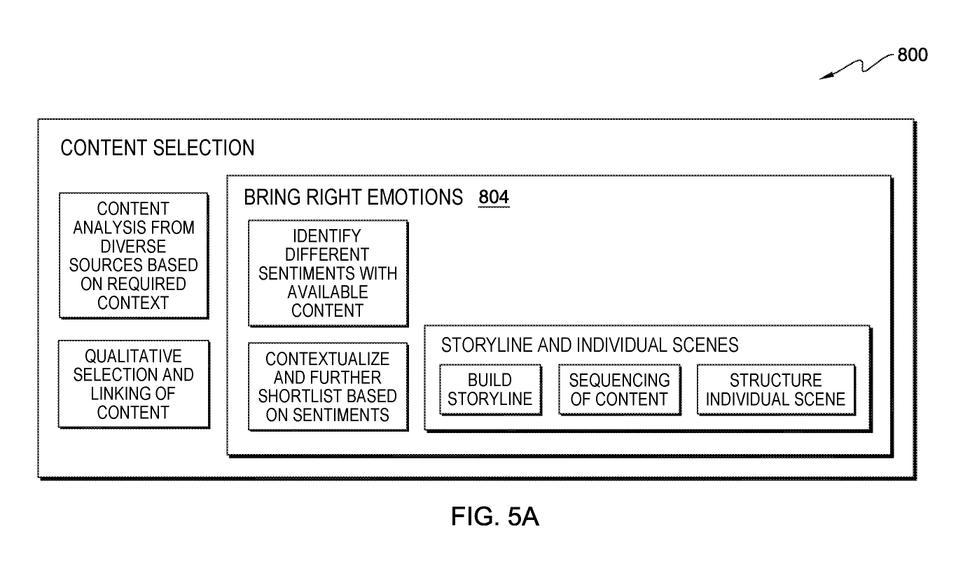

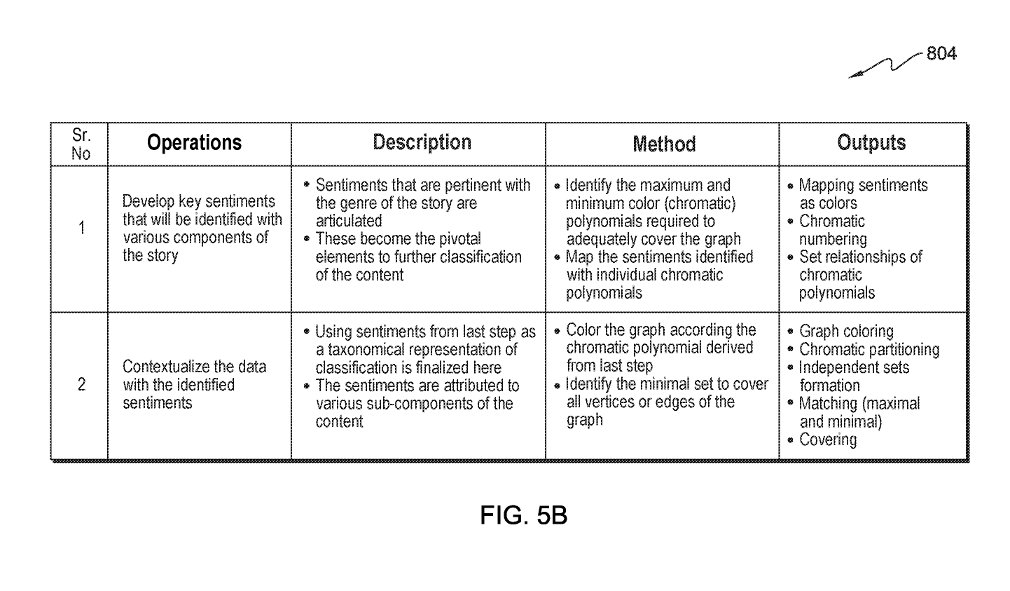

As shown in block diagram 800 of FIG. 5A, and summarized in table 804 of FIG. 5B, processing in some embodiments of the present invention, includes the following operations: (i) identifying different sentiments within available content, develop key sentiments; and (ii) contextualize and further shortlist the data based on the identified sentiments. This process will be described in greater detail in the following few paragraphs.

1. Build Chromatic Polynomials to Map Sentiments

Sentiments that are pertinent to the genre of the story are articulated. These sentiments become the pivotal elements to further classification of the content. The sentiments can be viewed as parameters that are attributed to every vertex in the graph. A maximum number of these sentiments are identified, that can be used in the creation of content, and do not bring uncontrollable variation in the data. This is achieved by mapping sentiments to various colors.

For example, suppose a graph G is given, with n vertices. A color is assigned to each vertex, such that no two adjacent vertices have the same color. Where all the vertices of a graph are colored such that no two adjacent vertices have the same color, is called the “proper coloring”, or simply coloring, of a graph. Consider C as a set “colors”.

C={C1,C2,C3, . . . Cn} Eq.(1)

Any function f: V→C is called a “coloring of the graph” G using n colors. For each vertex u, f(u) is the color of u.

C therefore represents the number of sentiments that are brought out in the graph. An author has the flexibility to choose any number of sentiments and check to see if these chosen sentiments are represented in the graph of findings.

The smallest number of colors that can produce a proper coloring of a graph G is called the chromatic number of graph G, denoted by χ(G).

Thus, a graph G that requires k different colors, and no fewer, for its proper coloring is called a m-chromatic graph and the number k is called the chromatic number of G.

χ(G)=k Eq.(2)

If δ(G) is the minimum degree of any vertex, and the total number of vertices are m, then chromatic number is given by:

$$χ ( G ) \geq \frac{m}{( m - δ ( G ) )} \qquad Eq . ( 3 )$$

Thus, Eq(3) shows the minimum number of colors that are needed to properly color the graph, meaning the minimum number of sentiments that should be in the current dataset.

Similarly, if Δ(G) is the largest degree of any vertex of G, then the maximum number of colors that can be applied to graph G is:

χ(G)≦1+Δ(G) Eq.(4)

Eq(4) gives the maximum number of sentiments that can be used in the current dataset.

From Eq(2) and Eq(3) the range of sentiments that can be applied to the graph G is:

$$\frac{m}{( m - δ ( G ) )} \leq χ ( G ) \leq 1 + ( G ) \qquad Eq . ( 5 )$$

Where χ(G)=the range of sentiments that can be applied to G

Using this model, the maximum number of sentiments that can be used to create the plot, based on the findings, is determined. Derived from the graph, therefore, is the maximum number of sentiments an author can use such that the plot is not diluted with too great a number of emotions. This number is given by chromatic number of the graph. The range is provided in Eq. (5).

2. Coloring Methodology of Graphs

Using sentiments as a taxonomical representation of classification is finalized. The sentiments are attributed to various sub-components of the content.

A proper coloring of a graph induces (or guides) a partitioning of the vertices into different subsets. No two vertices in any of these subsets are adjacent. Such a subset of vertices is called an independent set. A set of vertices in a graph is said to be an independent set of vertices or simply an independent set (or an internally stable set) if no two vertices in the set are adjacent.

We can thus use coloring as the taxonomy parallel for classification of the content.

The number of vertices in the largest independent set of a graph is called the independent number (or coefficient of internal stability) denoted by â(G).

For graph G, which is k-chromatic, by definition of “independent number”, the largest number of vertices in any proper coloring of G having the same color cannot exceed the independence number, therefore we have

$$\begin{matrix}k \cdot \hat{a} ( G ) \geq n & Eq . ( 6 ) \\ \hat{a} ( G ) {\geq }^{\frac{n}{k}} & Eq . ( 7 )\end{matrix}$$

Eq.(7) give the maximum number of vertices in the largest independent set for a given color or sentiment.

The largest independent set represents the color intensity, or the intensity of the sentiment, in the current graph, and therefore represents the prevalent sentiment in the articles. This gives the author flexibility to build the plot around the pivotal sentiment the author has applied.

Some embodiments of the present invention further determine certain subsets of the graph, referred to as sub-graphs as set forth below.

Minimum edge covering ECₘᵢₙ is a set “g” of edges, for which every vertex in G is incident on at least one edge in g and if no proper subset of g is an edge covering of G.

$${EC}_{m i n} = \frac{n + 1}{2} \qquad Eq . ( 8 )$$

Minimum vertex covering VCₘᵢₙ is a set “n” of vertices such that each edge of the graph is incident to at least one vertex of the set n. This is solved by the vertex cover algorithm of Eq.(9):

$${VC}_{m i n} = n - ( \frac{n}{Δ ( n ) + 1} ) \qquad Eq . ( 9 )$$

Author now has n number of articles being represented by the graph G. Thus the author has at least VCmin instances of articles that can be used for the story line. The author also has k sentiments that draw independent sets of which the largest set has â(G) number of articles in the disposition. The author can consider this to be a pivotal article and collect other related independent sets for the sub-componentization or further classification. The maximum reach of the author's research is given by the ECmin computation.

By applying this model, the author now has further shortlisted content with the right mix of emotions to ensure quality and cohesiveness of content along with the desired emotions.

Some embodiments of the present invention may include one, or more, of the following features, characteristics and/or advantages: (i) uses emotion (sentiment) relationships and taxonomical graph; (ii) uses advanced and robust technique that brings emotions in story content; (iii) applies colors to the nodes of the graph, the colors corresponding to respective sentiments (emotions); and/or (iv) uses cognitive intelligence to bring desired emotions into the story content.

Sentiments specified by an author become pivotal elements to guide further classification of the content. The number of sentiments specified by the author is the number of sentiments that are represented in the graph. The author has the flexibility to choose any number of sentiments and check if the chosen sentiments are represented in the graph of findings. Maximum and minimum color (chromatic) polynomials, required to adequately cover the graph, are identified. (Note: the minimum number of colors required to color a graph is called the chromatic number (k) of the graph. Eq.(5) above represents a chromatic polynomial providing a range of colors to be included in the graph.) Sentiments are mapped as colors. Sentiments identified with individual chromatic polynomials, are mapped to identify relationships of chromatic polynomials. This model indicates how many maximum sentiments are used to create a plot based on the findings. Thus, the graph is considered sacrosanct and derived therefrom is a maximum number of sentiments the author can use so that the plot is not diluted with too high a number of emotions. This number is given by the chromatic number of the graph.

In some embodiments of the present invention, use of sentiments identified as a taxonomical representation of classification is finalized. The sentiments are attributed to various sub-components of the content.

The graph is colored according the chromatic polynomial derived from last step—proper coloring of a graph induces a partitioning of the vertices into different subsets. No two vertices in any of these subsets are adjacent. Such a subset of vertices is called an independent set. The largest independent set represents the color intensity or the intensity of the sentiment (emotion) in the current graph. The largest independent set reveals what is the prevalent sentiment in the articles, and gives the author flexibility to build the plot around the pivotal sentiment the author has applied.

A minimal set to cover all vertices or edges of the graph for desired sentiments is identified. The author has n number of articles represented by the graph G. Thus the author is provided at least minimum vertex covering instances of articles that can be used for the story line. Author also has sentiments that draw independent sets of which the largest independent set has maximum number of articles in the disposition. The author takes this as the pivotal article and collects other related independent sets for the sub-componentization or further classification. The maximum reach of the author's research is given by the minimum edge covering computation.

Some embodiments of the present invention may include one, or more, of the following features, characteristics and/or advantages: (i) uses advanced and sophisticated techniques to bring emotions into the story content; (ii) uses emotion or sentiment relationships and a taxonomical graph; (iii) helps the author to determine if a given emotion is invoking the right media in the network, thus assess whether the emotion will work or not; (iv) based on the emotion, the system identifies which articles resonate with the desired emotion and provide the most relevant content; and/or (v) content curator algorithm recursively identifies and organizes scenes within a story line based on the rank and connection parity of the graph.

Some embodiments of the present invention: (i) use cognitive intelligence to define a storyline sequence and bring desired emotions into the story; (ii) do not need a theme script; (iii) use taxonomical graph to represent emotions and relationships among emotions; and/or (iv) helps an author to identify whether a given emotion invokes the right media in the network, thus assessing if the emotion will “work” (fit into the storyline) or not.

Some embodiments of the present invention identify which articles resonate with (or evoke) a given emotion and provides the most relevant content for further processing. A content curator algorithm recursively identifies and organizes the scenes within a storyline based on the rank and connection parity of the graph.

Some embodiments of the present invention may include one, or more, of the following features, characteristics and/or advantages: (i) applies graph theory to show the relationship of emotions in connected sub-plots or scenes and to compute the number of emotions; (ii) identifies the emotional relationships between the nodes through a color coding, to ensure that the movement along an edge also causes a change in the emotion; (iii) sentiments that are pertinent with the genre of a story are articulated by the author and become pivotal elements to further classification of the content; (iv) sentiments required by the author represent the number of sentiments that we are bringing out in the graph; (v) the author has flexibility to choose any number of sentiments and check if these sentiments are represented in the graph of findings; (vi) identifies the maximum and minimum color (chromatic) polynomials required to adequately cover the graph, and maps sentiments as colors; (vii) maps the sentiments identified with individual chromatic polynomials to identify relationships of chromatic polynomials; and (viii) provides advice on the maximum number of sentiments that can be used to create a plot based on the findings, thus, deriving from the graph the maximum number of sentiments (chromatic number of the graph) an author can use so that the plot is not diluted with too high a number of emotions.

Some embodiments of the present invention may further include one, or more, of the following features, characteristics and/or advantages: (i) identifies sentiments as a taxonomical representation of classification is finalized where the sentiments are attributed to various sub-components of the content; (ii) proper coloring the graph according the chromatic polynomial induces a partitioning of the vertices into different subsets in which no two vertices in any of these subsets are adjacent (each subset is called an independent set); (iii) the largest independent set represents the color intensity (the intensity of the sentiment) in the current graph, revealing the prevalent sentiment in the articles and giving the author flexibility to build the plot around the pivotal sentiment the author has applied; and (iv) identifies the minimal set that covers all vertices or edges of the graph for desired sentiments. The author has n number of articles represented by the graph G, and is provided at least a minimum vertex covering instances of articles that can be used for the story line. The author also has sentiments that draw independent sets of which the largest set has a maximum number of articles in the disposition. The author can treat this as a pivotal article and collect other related independent sets for the sub-componentization or further classification. Author has to bear in mind that the maximum reach of the author's research is given by the minimum edge covering computation.

Some embodiments of the present invention may include one, or more, of the following features, characteristics and/or advantages: (i) provides a method and system for story creation from diverse content collected from multiple sources by using a taxonomical graph model and adding desired emotions in the story content; (ii) creates a taxonomical graph for diverse content collected from multiple sources, wherein nodes of the graph represent the input content and edges represent linkage/relationship between the input content; (iii) color of the nodes represents emotions/sentiments; and (iv) identifies emotional relationships between the nodes through color coding to ensure that the movement along an edge causes a change in the emotions.

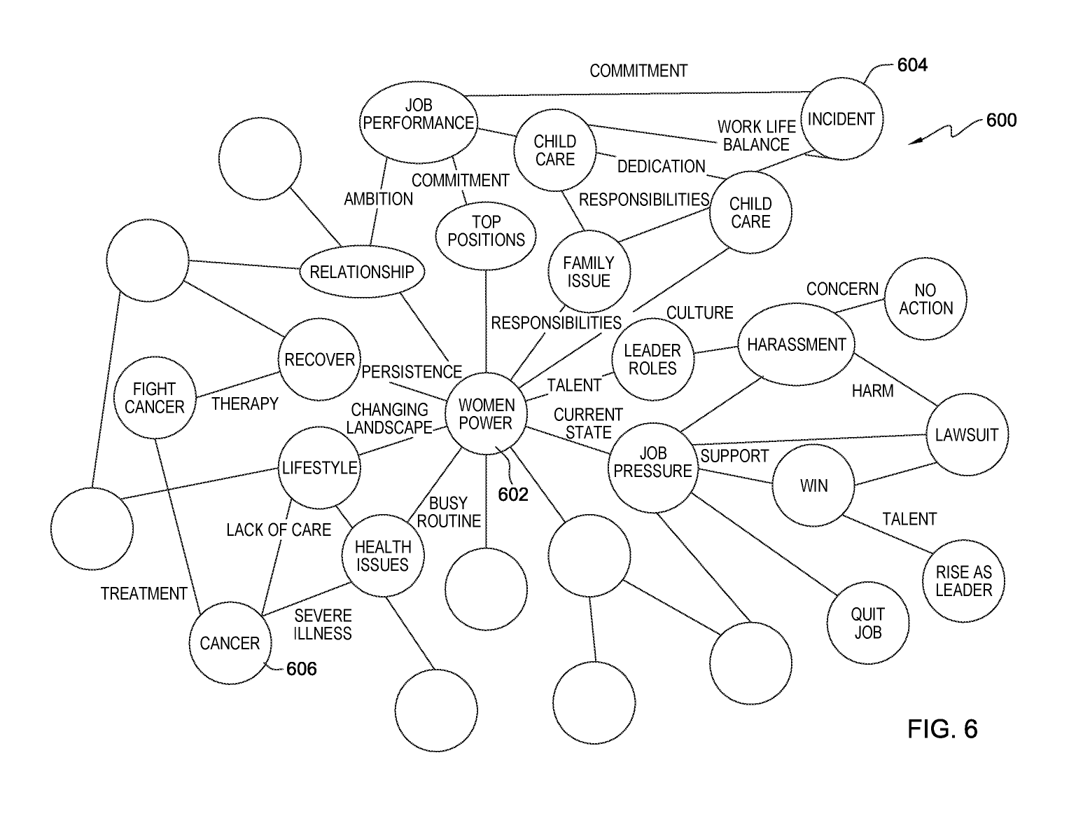

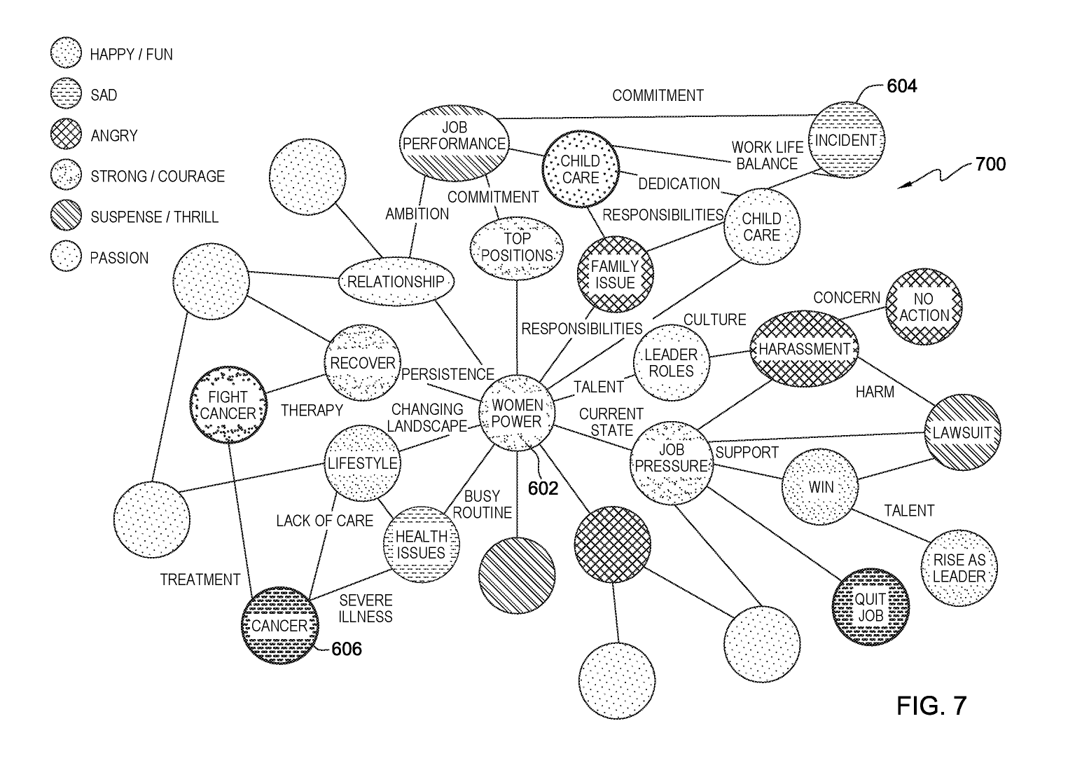

An example embodiment of the present invention will now be discussed with reference to graphs 600 and 700 of FIGS. 6 and 7 respectively. In some embodiments of the present invention: (i) graph 600, representing shortlisted content, is received as input; and graph 700 is generated, based on graph 600. Graph 700 indicates emotions (and intensities of the emotions) associated with the content represented by its nodes. In some embodiments of the present invention, different emotions are respectively represented with different colors, and the intensity (vividness) of each color is reflective of the intensity of the respective emotion.

Some embodiments of the present invention receive shortlisted content as input, and identify embedded emotions (and intensity of the emotions) in the content presented in the form of a graph, by performing the following steps, not necessarily in the order presented here: (i) identifies the maximum and minimum color (chromatic) polynomials required to adequately cover the graph; (ii) maps the emotions (sentiments) identified with individual chromatic polynomials; (iii) applies colors to the graph according the chromatic polynomial derived in step (ii) above; and/or (iv) identifies the minimal set to cover all vertices or edges of the graph.

Further with respect to item (i) in the paragraph above, adequate coloring of the graph follows two rules: (i) the number of colors is within the range between the minimum and maximum values respectively determined by Eqs.(3) and (4) above, and summarized in Eq.(5) above; and (ii) no two neighboring (adjacent) nodes have the same color.

In some embodiments of the present invention, an author uses the colored graph as input for story writing based on the author's choice of emotions and their intensity, along with linkages of content already defined in the graph. Note that the graphs 600 and 700 represent a very small example, and in practice, the graph would generally include a huge amount of shortlisted content. Based on choice of emotions and their intensity, pieces of content are selected or discarded.

An example of output yielded in some embodiments of the present invention, with reference to graph 700 of FIG. 7, includes emotions and corresponding intensities as illustrated in the following few paragraphs.

Women power node 602 is associated with an emotion of courage and strength (80% intensity). A sample of extracted content represented by node 602 includes: “Shree has achieved the position of account executive, a milestone that generally follows at least 15 years of experience, in just 8 years. She has been awarded with Best of Organization award consecutively for 2 years in recognition of her contributions on troubled information technology projects . . . .”

Incident node 604 is associated with an emotion of sadness (60% intensity). A sample of extracted content represented by node 604 includes: “Rick is completely devastated, knowing he will have to be on bed rest for several weeks with no access to friends or outdoor games, and staying alone at home . . . .”

Cancer node 606 is associated with an emotion of sadness (80% intensity). A sample of extracted content represented by node 606 includes: “Finally, Shree makes some time to diagnose health issues she has been facing for a long time. Results of the diagnosis are shocking!! . . . .”

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Automated story writing engine: any set of machine logic that facilitates in the composition of a story; an automated story writing engine, may, or may not output a fully completed story; an automated story engine may, or may not, make its output(s) in the form of human understandable language.

What is claimed is:

1. A computer-implemented method of writing an automated story, the method comprising:
receiving, by an automated story writing engine, a story data graph data set including data structured as a graph that includes a plurality of nodes and a plurality of connections among and between the nodes, with each given node including content data corresponding to content that can potentially be used as subject matter for the automated story and emotion value data relating to emotions related to the content of the given node;
receiving, by the automated story writing engine, a selected emotions data set corresponding to emotions that are desired to be used in the automated story;
selecting, by the automated story writing engine, a subset of recommended candidate nodes from the plurality of nodes, based, at least in part, upon the selected emotions data set and the emotion value data of the nodes of the story data graph; and
outputting data corresponding to an identity of the recommended candidate nodes.

2. The computer-implemented method of claim 1 further comprising:
determining, by machine logic of the automated story engine, the selected emotions data set.

3. The computer-implemented method of claim 1 wherein the output of the identity of the recommended candidate nodes is output in machine readable form and format to a further stage of an automated story writing process.

4. The computer-implemented method of claim 3 further comprising:
writing, by machine logic of further stages of the automated story writing engine, the automated story expressed in human understandable form and format.

5. The computer-implemented method of claim 1 further comprising:
providing a user interface that allows a human user to provide user input; and
generating, by the automated story writing engine and based, at least in part, upon the user input, the selected emotions data set.

6. The computer-implemented method of claim 1 further comprising:
receiving, by an automated story writing engine, an emotion ordering data set corresponding to an order of emotions that is desired to be used in the automated story; and
determining, by the automated story writing engine, an ordering of the recommended candidate nodes based, at least in part, upon the emotion ordering data set and the emotion value data of the recommended candidate nodes.

7. A computer-implemented method of writing an automated story, the method comprising:
receiving, by an automated story writing engine, a story data graph data set including data structured as a graph that includes a plurality of nodes and a plurality of connections among and between the nodes, with each given node including content data corresponding to content that can potentially be used as subject matter for the automated story and emotion value data relating to emotions related to the content of the given node;
receiving, by the automated story writing engine, an emotion ordering data set corresponding to an order of emotions that is desired to be used in the automated story;
determining, by the automated story writing engine, an ordering for a subset of nodes, with the subset of nodes including at least some nodes of the plurality of nodes, based, at least in part, upon the emotion ordering data set and the emotion value data of the nodes of the story data graph; and
outputting data corresponding to the ordering of the subset of nodes.

8. The computer-implemented method of claim 7 further comprising:
determining, by machine logic of the automated story engine, the emotion ordering data set.

9. The computer-implemented method of claim 7 wherein the output of the ordering of the subset of nodes is output in machine readable form and format to a further stage of an automated story writing process.

10. The computer-implemented method of claim 9 further comprising:
writing, by machine logic of further stages of the automated story writing engine, the automated story expressed in human understandable form and format.

11. The computer-implemented method of claim 7 further comprising:
providing a user interface that allows a human user to provide user input; and
generating, by the automated story writing engine and based, at least in part, upon the user input, the emotion ordering data set.

12. The computer-implemented method of claim 7 further comprising:
receiving, by an automated story writing engine, a selected emotions data set corresponding to emotions that are desired to be used in the automated story; and
determining, by the automated story writing engine, a subset of recommended candidate nodes from the plurality of nodes, based, at least in part, upon the selected emotions data set;
wherein the subset of nodes corresponds to the recommended candidate nodes.

13. A computer-implemented method of writing an automated story, the method comprising:
receiving, by an automated story writing engine, a story data graph data set including data structured as a graph that includes a plurality of nodes and a plurality of connections among and between the nodes, with each given node including content data corresponding to: (i) content that can potentially be used as subject matter for the automated story, and (ii) emotion value data relating to emotions related to the content of the given node;
receiving, by the automated story writing engine and from a seeder entity, emotion seed data relating emotions and/or emotional flow that the automated story is desired to exhibit;
for each given node of the story data graph, translating the emotion value data in the form of a color value for the given node;
identifying a maximum chromatic polynomial required to adequately cover emotion seed data based, at least in part, upon the color values of the nodes of the story data graph;
identifying a minimum chromatic polynomial required to adequately cover emotion seed data based, at least in part, upon the color values of the nodes of the story data graph; and
identifying relationships of the maximum chromatic polynomial and the minimum chromatic polynomial by mapping emotions identified by the minimum and maximum chromatic polynomials.

14. The computer-implemented method of claim 13 further comprising:
recommending a maximum number of emotions that can be used to create a plot based on analysis of the minimum and maximum chromatic polynomials.

15. The computer-implemented method of claim 14 further comprising:
determining a chromatic number of the story data graph based, at least in part, upon the color values of the nodes of the story data graph.

16. The computer-implemented method of claim 15 wherein the recommendation of maximum number of emotions is further based, at least in part, upon the chromatic number of the story data graph.

17. The computer-implemented method of claim 13 wherein:
identifying the minimum chromatic polynomial using the formula
$$\frac{m}{( m - δ ( G ) )}$$
where m is the total number of vertices of the graph, and δ(G) is the minimum degree of any vertex of the graph; and
identifying the maximum chromatic polynomial using the formula 1+Δ(G)
where Δ(G) is the largest degree of any vertex of the graph.
